(19) United States
(12) Patent Application Publication
(10) Pub. No.: US 2025/0302006 A1
(43) Pub. Date: Oct. 2, 2025

(54) AUTOMATED LEASH CONTROL DEVICE FOR DOGS

(71) Applicants: Shuji Fukami, Palma (ES); Xavier Lafuerza Garcia, Barcelona (ES)

(72) Inventors: Shuji Fukami, Palma (ES); Xavier Lafuerza Garcia, Barcelona (ES)

(21) Appl. No.: 18/619,246

(22) Filed: Mar. 28, 2024

(51) Int. Cl. A01K 15/02; A01K 27/00; A01K 29/00

(52) U.S. Cl. CPC A01K 15/021; A01K 27/001; A01K 27/004; A01K 29/005

(57) ABSTRACT

The embodiments herein disclose an automated leash control device for dogs, which aims to optimize the communication and behavior management between a dog and its handler during walks or training sessions. The device utilizes sensors to monitor leash tension, speed, and distance, coupled with a motorized mechanism for controlling leash extension speed. Additionally, the device integrates with an Innovative E-collar, providing compressed air signaling to alert the dog, thereby enhancing training outcomes.

### TECHNICAL FIELD

The present disclosure relates to an automated leash control device for dogs, which aims to optimize the communication and behavior management between a dog and its handler during walks or training sessions. The device utilizes sensors to monitor leash tension, speed, and distance, coupled with a motorized mechanism for controlling leash extension speed. Additionally, the device integrates with an Innovative E-collar, providing compressed air signaling to alert the dog, thereby enhancing training outcomes.

### BACKGROUND

The relationship between a dog and its handler is one of the most crucial aspects of dog ownership and training. Effective communication and control during walks or training sessions play a significant role in shaping the behavior and obedience of the dog. The leash serves as the primary means of physical communication between the handler and the dog, making its handling technique crucial for achieving desired outcomes.

Traditional methods of leash handling often involve manual control by the handler, relying on physical strength and coordination to manage the dog's movements. However, these methods have several limitations such as lack of precision in which the manual leash handling may lack precision, leading to inconsistent guidance and communication with the dog. This can result in confusion or frustration for both the handler and the dog, hindering the training process.

Traditional leashes typically offer limited customization options, such as fixed lengths or simple locking mechanisms. This lack of flexibility makes it challenging to adapt to various training scenarios or adjust to the specific needs of individual dogs. Manual leash handling may pose a risk of injury to both the handler and the dog, particularly if the dog pulls forcefully or unexpectedly. Handlers may experience strain or injury to their hands, arms, or shoulders, while dogs may suffer from discomfort or injury due to excessive pulling or jerking.

Without precise control and communication through the leash, training sessions may be less effective, requiring more time and effort to achieve desired behaviors. This inefficiency can frustrate both the handler and the dog, leading to slower progress and potentially undermining the training relationship.

The limitations of traditional leash handling methods highlight the need for innovative solutions that can enhance communication, control, and safety during walks or training sessions. By leveraging advancements in sensor technology and automation, the present invention seeks to address these challenges and provide a more effective and efficient approach to leash control for dogs.

In conventional methods, the pet owners, especially dog owners, and trainers have used the training collar and leash as the standard method of obedience training. The training is accomplished by simply pulling or jerking on the dog's leash. Many dog owners, fear of injuring the dog, have a tendency to correct the dog with mild jerks. This method of correction may require several hundred jerks to correct the dog's behavior. Professional trainers may have a tendency of jerking the dog much harder than the owner, and are able to correct the dog's behavior with a minimum of jerks on the leash.

The fundamental problem with conventional leash training is the inherent inconsistency in delivery of the corrective stimulus. For any given dog, the magnitude and frequency of the corrective stimulus is dependent upon the nature of the person delivering the stimulus. This lack of consistency in the magnitude and frequency of the corrective stimulus certainly has the potential for being, and is believed to be, confusing to the dog. This is especially true when both the professional trainer and the pet owner are jerking the leash in different ways during the same period of training.

Also, the dog leash may be secure, control, and/or restrain a dog being controlled by a walker (e.g., an owner of the dog, a friend of the owner, a professional caretaker). The walker may take the dog for a walk in an urban area in which there is significant vehicular traffic while the dog is wearing the dog leash. For example, the walker may traverse busy intersections and/or roads when walking the dog controlled through the dog leash. In addition, the walker may take the dog out in evening or night hours, when lighting outside is dim (e.g., in evening hours). In such instances, oncoming cars may pose a significant threat to physical safety of both the walker and the dog because they may not see the walker and/or the dog (e.g., while crossing a street).

Therefore, the fundamental problem with the conventional leash training is the inconsistency in delivering the training method. For example, any given dog, the frequency of providing leash training may depend upon the nature of the person delivering the training. The lack of consistency in the magnitude and frequency of the corrective stimulus certainly has the potential for being, and is believed to be, confusing to the dog. This is especially true when both the professional trainer and the pet owner are jerking the leash in different ways during the same period of training.

Also, in certain cases it is difficult for individuals to directly handle animals or to train them. For example, an elderly person may be physically unable to train and control the pet such as dog by himself. However, it is often necessary for such an individual to be able to control the animal so that necessary chores, such as guarding the house from strangers, identifying the thieves, and the like, can be performed. Although a pet owner, need some amount of training to control the dogs using the leash. Therefore, there is the need for a remote-control apparatus by which one person can remotely control the movement of an animal without having to physically mount and guide the animal.

In addition to those people who are unable to directly physically control an animal, there are those who desire to break or train animals, but who are unable to do so because of the hazards involved with such tasks. Therefore, there is also the need for a remote-control apparatus which can be used to train an animal.

The present invention seeks to address these limitations by providing an automated leash control device that enables more effective communication and guidance between the handler and the dog. By automating leash handling and integrating advanced features such as tension control, extension speed control, and synchronization with an Innovative E-collar, the proposed device aims to revolutionize the way handlers communicate and interact with their dogs. This innovative approach offers numerous benefits, including improved behavior management, customizable control, enhanced training experiences, and increased safety for both handlers and dogs.

### SUMMARY

The principal object of the present disclosure is to provide a dog to learn, think, and act correctly by guiding them through the leash. This is achieved by automating leash control using advanced sensor technology and a motorized mechanism.

Further object of the present disclosure is to provide a tension control using the sensors which are embedded within the leash to monitor the load (power) applied by the dog and adjust tension accordingly to ensure optimal control and comfort.

Another object of the present disclosure is to provide an extension speed control, through the devices which regulate the speed at which the leash extends or retracts based on real-time data collected from sensors, allowing for smooth and controlled movement.

Further object of the present disclosure is to provide an automated leash control device to guide the dogs to learn, think, and act in a better manner, thereby making the tasks of the trainer easier.

Another object of the present disclosure is to synchronize the collected data from the sensors of the load, speed and the distance which are embedded into the devices, with the innovative E-collar which can alert dogs by compressed air signaling.

### BRIEF DESCRIPTION OF FIGURES

Embodiments herein are illustrated in the accompanying drawings, throughout which like reference letters indicate corresponding parts in the various figures. The embodiments herein will be better understood from the following description with reference to the drawings, in which:

FIG. 1 is an example diagram illustrating a motorized leash attached to an electronic collar, according to embodiments as disclosed herein;

FIGS. 2A, 2B and 2C are example diagrams illustrating the sample motorized leash of the user side, and its inner components accordingly, according to embodiments as disclosed herein;

FIG. 3 is an example diagram illustrating the configuration of a tension sensor installed in the leash, according to embodiments as disclosed herein;

FIG. 4 is an example diagram illustrating the acceleration blocking mechanism attached to the leash mechanism, according to embodiments as disclosed herein;

FIGS. 5 and 6 are example diagrams illustrating the configuration of the microcontroller and spiral spring to the leash system for controlling the behavior of the pet, according to embodiments as disclosed herein; and

FIG. 7 is an example diagram illustrating an electronic collar to be worn by the dog for controlling its behavior, according to embodiments as disclosed herein.

### DETAILED DESCRIPTION

The example embodiments herein and the various features and advantageous details thereof are explained more fully with reference to the non-limiting embodiments that are illustrated in the accompanying drawings and detailed in the following description. Descriptions of well-known components and processing techniques are omitted to not unnecessarily obscure the embodiments herein. The description herein is intended merely to facilitate an understanding of ways in which the example embodiments herein can be practiced and to further enable those of skill in the art to practice the example embodiments herein. Accordingly, this disclosure should not be construed as limiting the scope of the example embodiments herein.

In the following description, for the purposes of explanation, numerous specific details are set forth in order to provide a thorough understanding of implementations of the present technology. It will be apparent, however, to one skilled in the art that implementations of the present technology can be practiced without some of these specific details.

Described in detail below is the concept of all-inclusive co-working space based on a membership model, which provides a collaborative and inspiring work environment to professionals and independent workers like freelancers, entrepreneurs, students, and others.

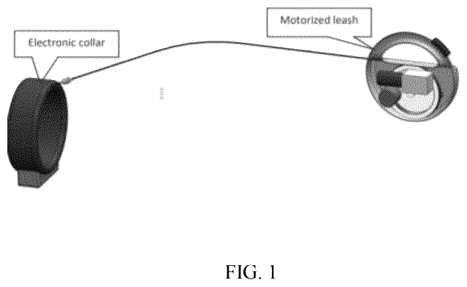

FIG. 1 is an example diagram illustrating a motorized leash attached to an electronic collar, according to embodiments as disclosed herein. As illustrated in FIG. 1, the claimed invention aims at providing an automatic leash controlling mechanism, to empower dogs to learn, think, and act correctly by guiding them through the leash. This is achieved by automating leash control using advanced sensor technology and a motorized mechanism. The automatic leash controlling mechanism focuses on tension control and extension speed control mechanism. The claimed invention provides sensors embedded within the leash monitor the load (power) applied by the dog and adjust tension accordingly to ensure optimal control and comfort. The device regulates the speed at which the leash extends or retracts based on real-time data collected from sensors, allowing for smooth and controlled movement.

In an embodiment, the automatic leash controlling mechanism comprises sensors which may include, but are not limited to a load sensor, encoder sensor, speed sensors and the like. The load sensor may be configured to measure the pressure applied by the dog on the leash, providing feedback to the control mechanism. The encoder sensor can be configured to determine the sped and distance traveled by the dog, enabling precise control of the leash extension and retraction. The motorized mechanism may be configured to utilize the motor and gearbox to control the extension speed of the leash, ensuring consistent and customizable handling. The device synchronizes with an Innovative E-collar, which utilizes compressed air signaling to alert the dog during training sessions, enhancing training effectiveness and responsiveness.

As illustrated in FIG. 1, the leash control system comprises an electronic collar and a motorized leash, in which the motorized leash can be used on the user side and the electronic collar can be configured with the wearable by the dog. The load sensor is a crucial component which can be configured to the automated leash control device, responsible for measuring the pressure applied by the dog on the leash. This sensor typically utilizes strain gauge technology, which detects changes in resistance as the leash experiences tension. The sensor is strategically embedded within the leash structure to accurately capture the force exerted by the dog during walks or training sessions.

The load sensor can be configured to continuously monitor the tension exerted on the leash and provides real-time feedback to the control mechanism of the device. This feedback enables the device to dynamically adjust the tension to maintain optimal control and comfort for both the handler and the dog. Therefore, the load sensor is integrated into the leash design, ensuring seamless functionality without compromising the leash's flexibility or durability. Advanced materials and manufacturing techniques may be employed to ensure the sensor's reliability and longevity in various environmental conditions.

The encoder sensor can be configured to the electronic collar (E-collar), which plays a vital role in determining the speed and distance traveled by the dog, providing essential data for controlling leash extension and retraction. This sensor utilizes rotary or linear encoding technology to accurately measure the movement of the leash relative to the handler.

The encoder sensor can be configured to racks the rotation or linear movement of a specific component within the leash mechanism, such as a spool or pulley system. By analyzing the sensor data, the device can calculate the dog's speed, distance, and direction of movement, enabling precise control of leash extension and retraction.

The encoder sensor is strategically integrated into the device's mechanism, ensuring accurate measurement of leash movement without impeding its functionality or adding significant bulk. High-resolution encoders and sophisticated signal processing algorithms may be employed to enhance the sensor's precision and reliability.

The motorized mechanism serves as the driving force behind the automated leash control device, enabling precise control of leash extension speed based on sensor data. This mechanism typically consists of a motor, gearbox, and associated control electronics, responsible for driving the movement of the leash in response to user inputs and sensor feedback.

The motorized mechanism translates the control signals received from the device's microcontroller into mechanical motion, allowing for smooth and controlled extension or retraction of the leash. The motor's speed and torque characteristics are carefully selected to ensure optimal performance and energy efficiency.

The motorized mechanism is integrated into the device's housing, along with the load sensor and encoder sensor, to form a compact and robust system. Precision-engineered components and advanced control algorithms are employed to achieve smooth and responsive leash control under various operating conditions.

As illustrated in FIG. 1, the leash control system can be configured with the electronic collar (E-Collar). In addition to leash control functionality, the device integrates with an Innovative E-collar, which utilizes compressed air signaling to alert the dog during training sessions. This integration enhances the training experience by providing additional stimuli and feedback to the dog, promoting faster learning and compliance.

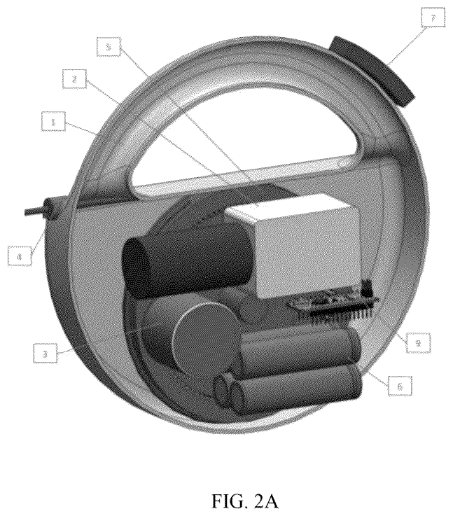

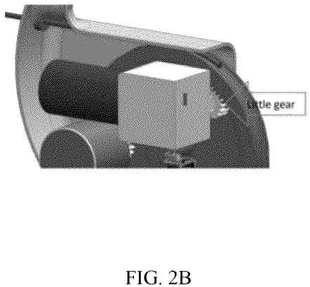

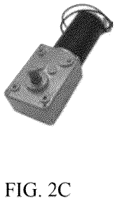

FIGS. 2A, 2B and 2C are example diagrams illustrating the sample motorized leash of the user side, and its inner components accordingly. As illustrated in FIG. 2A, the user side of the system comprises a body (1), a DC gear motor (2), an encoder (3), a limit switch (4), a main gear (leash ring) (5), a battery (6), a button connected to motor-to-main gear coupling mechanism (clutch) (7), an acceleration blocking mechanism (8), a microcontroller (9), and a spiral spring (10).

As illustrated, the body (1) of the leash system will be made of injection molding plastic—two halves bolted by screws. It can contain jigs inside the body (1) needed to securely fix all other internal components. FIG. 2B illustrates a gear motor which can be configured to the leash system. The DC gear motor (2) is the main part of the system. The motor torque must be calculated taking into account a maximal dog weigh and force: the stronger and heavier a dog—the more powerful gearmotor is needed. Also desired speed of the leash retraction should be calculated.

FIG. 2C illustrates a gear configured on the leash system. As illustrated, the gear motor (2) can be equipped with little gear to be connected to the main big gear (main ring). Also, the incremental encoder can be used to count the number of turns of the leash ring (5). The system being connected to the microcontroller (9), the sensor can calculate the speed of the leash gear (ring) (5). The cheapest incremental encoder can be used to operate the leash system. Also, the encoder (3) should be used with a small limit switch in order to signal the controller about the “zero” (fully retracted) position. Therefore, when the leash is fully retracted the tension sensor body presses the green button on the limit switch and the microcontroller stops the gearmotor.

The user side components comprise the body (1) in which the leash system can be made of injection-molded plastic, consisting of two halves bolted together by screws. It provides housing and structural support for all internal components. The DC Gear Motor (2) serves as the as the main power source for the system. Its torque is calculated based on factors such as the maximum weight and force of the dog, as well as the desired speed of leash retraction. The encoder (3) is used to count the number of turns of the leash ring (main gear) (5). It is typically an incremental encoder that provides feedback to the microcontroller (9) to calculate the speed of the leash gear.

As illustrated the limit switch (4) is used in conjunction with the encoder to signal the microcontroller about the “zero” position (fully retracted) of the leash. When the leash is fully retracted, the tension sensor body presses the green button on the limit switch, prompting the microcontroller to stop the gear motor.

The main gear (5), also known as the leash ring, is connected to the gear motor (2) and serves as the primary mechanism for extending and retracting the leash. The battery (6) provides power to the system, enabling the operation of the gear motor and other electronic components.

The button connected to Motor-to-Main Gear Coupling mechanism (clutch) (7), he button is part of the coupling mechanism (clutch) between the motor and the main gear. It allows the user to manually engage or disengage the motor from the main gear, providing flexibility in controlling leash movement.

The acceleration blocking mechanism (8) prevents sudden or rapid movements of the leash, enhancing user control and safety during walks or training sessions. The microcontroller (9) serves as the brain of the system, receiving inputs from sensors such as the encoder and limit switch and controlling the operation of the gear motor and other components based on predefined algorithms and user commands.

The spiral spring (10) may be used as part of the mechanism for retracting the leash, providing tension and assisting in the smooth operation of the system.

The body of the leash system is constructed from injection-molded plastic, ensuring durability and structural integrity. The gear motor is selected based on the specific requirements of the system, including torque, speed, and power consumption. The encoder is integrated with the gear motor to provide feedback on leash movement, allowing the microcontroller to accurately control leash extension and retraction. The limit switch is strategically positioned to detect the fully retracted position of the leash, enabling automatic stopping of the gear motor to prevent over-retraction. The microcontroller is programmed with algorithms to coordinate the operation of all components and respond to user inputs, ensuring smooth and reliable performance of the leash system.

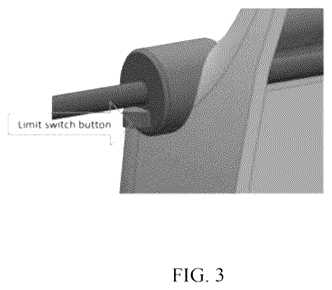

FIG. 3 is an example diagram illustrating the configuration of a tension sensor installed in the leash, according to embodiments as disclosed herein. The limit switch button (4) can be configured to the leash system. As illustrated, the main ring (main gear) (5) will be made of high strength injection molding plastic. The strength of the ring should be tested and correspond to a dog force.

In another embodiment, the battery (6) should correspond to the gearmotor voltage. In an example on using 3.7 V battery No18650—4 batteries will be needed to supply 12V DC motor. 9-12 V is also needed to supply Arduino microcontroller. 4 batteries No18650 will have 30-50 Wh capacity. The working time can be calculated only practically—the main power consumer will be the motor. The charging time will depend on the motor using frequency and time. To avoid excessive weight, a battery per 2 walks should be selected with the notification indicator.

In another embodiment, the button (7) will be injection molded plastic with ergonomical shape comfortable for a user. The button (7) should be equipped with a clutch (motor coupling mechanism) which should be custom-designed. i.e. the gearmotor is not permanently connected to the main ring. When the button is pressed back (unpressed, un-pushed)—the motor is disconnected from the main ring and the dog can easily extend the leash. When the button (7) is pushed—the clutch connects the motor to the main ring. If the motor is stopped it works as a brake, and the leash cannot freely extend when a dog goes forward.

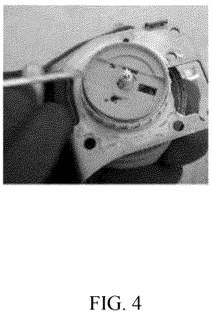

FIG. 4 is an example diagram illustrating the acceleration blocking mechanism attached to the leash mechanism, according to embodiments as disclosed herein. The acceleration blocking mechanism (8) can be attached to the main gear (main ring) (5) and works the same way as a seatbelt acceleration blocking mechanism. For an instance, when a dog accelerates too quickly, the mechanism blocks the main gear (5) and the leash is stopped. To release the leash, the dog should move calmly. There are no available compact mechanisms on the market and it should be custom-designed.

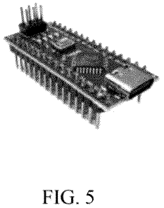

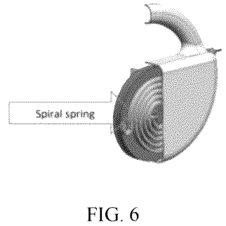

FIGS. 5 and 6 are example diagrams illustrating the configuration of the microcontroller and spiral spring to the leash system for controlling the behavior of the pet, according to embodiments as disclosed herein. In another embodiment, Arduino Nano can be used as the microcontroller (9). The controller should be programmed to: • Receive the signal from the limit switch (4): when the limit switch button (4) is pushed the controller interprets the leash is fully retracted (zero position) • Count the signals from the encoder—the proper formula will allow to calculate how far a dog had extended the leash • Control the battery charge and the like.

As illustrated in FIG. 6, the spiral spring (10) can be attached to the main gear (main ring) (5) and provides automatic retraction when the motor is disconnected from the main ring and a dog goes backward, providing support to the users.

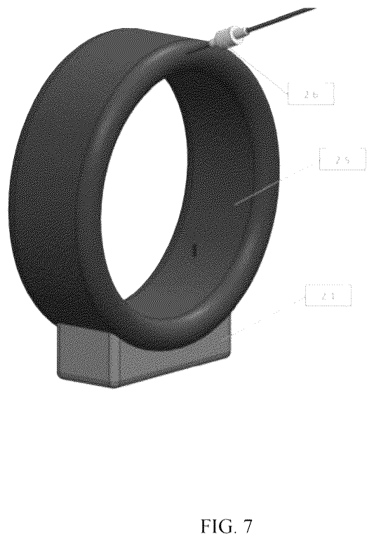

FIG. 7 is an example diagram illustrating an electronic collar to be worn by the dog for controlling its behavior, according to embodiments as disclosed herein. As illustrated in FIG. 7, the electronic collar comprises a plastic enclosure (2.1), a set of batteries (2.2), a miniature pneumatic pump (2.3), a microcontroller (2.4), a pneumatic (inflatable) collar (2.5) and a tension sensor (2.6).

As illustrated, the electronic collar will be made of injection molding plastic (2.1) in which two halves bolted by screws. It should contain jigs needed to securely fix all internal components. The batteries (2.2.) can be No18650 or other type to supply the miniature pump and should correspond in voltage. They will also supply the collar microcontroller. The pump (2.3.) should be miniature and light to be able to fit inside the enclosure.

As illustrated, the Arduino Nano microcontroller (2.4) can be used in the collar—it should receive data from the tension sensor (2.6) and the battery charge data. Both controllers (in the collar and in the leash) should have Bluetooth module. The dog side controller will transmit data to the main (user side) controller (9). The pneumatic (inflatable) collar (2.5) should be custom-designed. The tension sensor (2.5) can be configured to control the extension speed (tension) on leash. The encoder sensor can measure the speed and distance travelled by the dog and the user. The load sensor can measure the force provided by the dog in pulling.

The device synchronizes with the E-collar via wireless communication protocols, allowing for seamless integration and coordination of training stimuli. When triggered by predefined conditions, such as excessive leash tension or rapid movement, the E-collar delivers a compressed air signal to alert the dog and reinforce desired behaviors.

The integration with the E-collar is achieved through dedicated hardware and software interfaces, ensuring compatibility and reliability. Advanced signal processing algorithms and training protocols may be employed to optimize the effectiveness of the compressed air signaling and minimize the risk of overstimulation or discomfort to the dog.

The advantages and benefits of the leash control system may provide an improved behavior management, the automated leash control device enhances the handler's ability to guide the dog effectively, leading to better behavior outcomes and a stronger bond between the dog and its owner.

The leash control system may provide a customizable control, the handlers can adjust the leash tension and the extension speed based on environmental factors, the dog's behavior, and specific training requirements. Also, the enhanced training experience, the integration of an E-collar adds an additional layer of training stimuli, promoting faster learning and compliance while minimizing the risk of harm to the dog.

The target market for the invention includes dog owners, professional trainers, and organizations involved in animal training and rehabilitation. The device offers a comprehensive solution to address the diverse needs of stakeholders in the pet care industry, ranging from basic obedience training to advanced behavioral modification programs.

While traditional retractable leashes and manual training methods are prevalent in the market, the proposed device stands out due to its advanced features, precision control, and customizable functionality. Existing products lack the automation and synchronization capabilities offered by the invention, making it a unique and valuable proposition for dog owners and trainers alike. The invention is technically feasible and practical, utilizing off-the-shelf components and advanced sensor technology. The core components, including load sensors, encoder sensors, and motorized mechanisms, are readily available and can be integrated into the device design with relative ease.

The automated leash control device for dogs represents a significant advancement in pet care technology, offering a comprehensive solution for behavior management and training. Its innovative features, including automated tension and speed control, set it apart from traditional leash handling methods, making it a valuable asset for dog owners and trainers seeking to enhance the communication and bond with their canine companions.

1. A leash control device for dogs comprising:
a load sensor for measuring pressure applied by the dog on the leash, wherein said load sensor is embedded within the leash structure to accurately capture the force exerted by the dog during walks or training sessions;
an encoder sensor for determining the speed and distance traveled by the dog, wherein said encoder sensor utilizes rotary or linear encoding technology to measure the movement of the leash relative to the handler;
a motorized mechanism for controlling the extension speed of the leash based on sensor data, wherein said motorized mechanism consists of a motor, gearbox, and associated control electronics, responsible for driving the movement of the leash in response to user inputs and sensor feedback;
integration with an Innovative E-collar for providing compressed air signaling to alert the dog during training sessions, wherein said integration enables seamless coordination of training stimuli and reinforcement of desired behaviors.

2. The device of claim 1, wherein the tension control mechanism adjusts leash tension dynamically based on data collected from the load sensor and encoder sensor, thereby maintaining optimal control and comfort for both the handler and the dog.

3. The device of claim 1, wherein the extension speed control mechanism regulates the speed at which the leash extends or retracts to ensure smooth and controlled movement, wherein said control mechanism utilizes motor speed and torque characteristics to achieve optimal performance and energy efficiency.

4. The device of claim 1, wherein the integration with the E-collar is achieved through wireless communication protocols, allowing for seamless coordination of training stimuli, wherein said E-collar delivers compressed air signaling to alert the dog when triggered by predefined conditions, such as excessive leash tension or rapid movement.

5. The device of claim 1, wherein the load sensor, encoder sensor, and motorized mechanism are integrated into the device's housing to form a compact and robust system, wherein precision-engineered components and advanced control algorithms are employed to achieve smooth and responsive leash control under various operating conditions.

6. The device of claim 1, wherein the integration with the E-collar is facilitated through dedicated hardware and software interfaces, ensuring compatibility and reliability, wherein advanced signal processing algorithms and training protocols are employed to optimize the effectiveness of the compressed air signaling and minimize the risk of overstimulation or discomfort to the dog.

7. A method for controlling a leash for dogs comprising:
measuring pressure applied by the dog on the leash using a load sensor embedded within the leash structure;
determining the speed and distance traveled by the dog using an encoder sensor;
controlling the extension speed of the leash based on sensor data using a motorized mechanism;
providing compressed air signaling to alert the dog during training sessions using an Innovative E-collar.

8. The method of claim 7, further comprising dynamically adjusting leash tension based on data collected from the load sensor and encoder sensor to maintain optimal control and comfort for both the handler and the dog.

9. The method of claim 7, further comprising regulating the speed at which the leash extends or retracts to ensure smooth and controlled movement, wherein motor speed and torque characteristics are utilized to achieve optimal performance and energy efficiency.

10. The method of claim 7, further comprising synchronizing with the E-collar via wireless communication protocols to facilitate seamless coordination of training stimuli, wherein compressed air signaling is delivered to alert the dog when triggered by predefined conditions, such as excessive leash tension or rapid movement.
